(19) United States
(12) Patent Application Publication
(10) Pub. No.: US 2012/0198124 A1
(43) Pub. Date: Aug. 2, 2012

(54) METHODS AND SYSTEMS FOR OPTIMIZING READ OPERATIONS IN A NON-VOLATILE MEMORY

(75) Inventors: Daniel J. Post, Campbell, CA (US); Matthew Byom, Campbell, CA (US); Michael Williams, Sunnyvale, CA (US)

(73) Assignee: Apple Inc., Cupertino, CA (US)

(21) Appl. No.: 13/015,735

(22) Filed: Jan. 28, 2011

(51) Int. Cl. G06F 12/00

(52) U.S. Cl. 711/103; 711/E12.008

(57) ABSTRACT

Systems and methods are disclosed for increasing efficiency of read operations by selectively re-ordering a sequence in which logical block addresses (“LBAs”) are read out of multi-level cell (“MLC”) non-volatile memory. In one embodiment, the LBAs can correspond to upper and lower pages. Because data stored in lower pages can be retrieved from NVM faster than data stored in upper pages, embodiments disclosed herein can selectively re-order the LBAs such that the first LBA to be read corresponds to a lower page.

### BACKGROUND OF THE DISCLOSURE

NAND flash memory, as well as other types of non-volatile memory (“NVM”), is commonly used in electronic devices for mass storage. For example, consumer electronics such as portable media players often include flash memory to store music, videos, and other media. Users of these electronics expect them to operate quickly, thereby providing a desired user experience. Accordingly, systems and methods for increasing efficiency of NVM operations are needed.

### SUMMARY OF THE DISCLOSURE

Systems and methods are disclosed for increasing efficiency of read operations by selectively re-ordering a sequence in which logical block addresses (“LBAs”) are read out of multi-level cell (“MLC”) non-volatile memory. In one embodiment, the LBAs can correspond to upper and lower pages. Because data stored in lower pages can be retrieved from NVM faster than data stored in upper pages, embodiments disclosed herein can selectively re-order the LBAs such that the first LBA to be read corresponds to a lower page.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 is an illustrative block diagram of a system in accordance with various embodiments of the invention;

FIG. 2 is an illustrative block diagram showing in more detail a portion of a NVM package in accordance with an embodiment of the invention;

FIG. 3 shows illustrative timing diagrams for performing read operations on lower pages and upper pages in accordance with embodiments of the invention;

FIG. 4 shows an illustrative timing diagram of a multi-page read operation in accordance with an embodiment of the invention;

FIG. 5 illustrates a flowchart for selectively re-ordering a LBA access sequence in accordance with an embodiment of the invention;

FIGS. 6A and 6B show illustrative examples of selective re-ordering of LBAs in accordance with various embodiments of the invention; and

FIG. 7 illustrates a flowchart for selectively re-ordering a LBA access sequence for MLC NVM in accordance with an embodiment of the invention.

### DETAILED DESCRIPTION OF THE DISCLOSURE

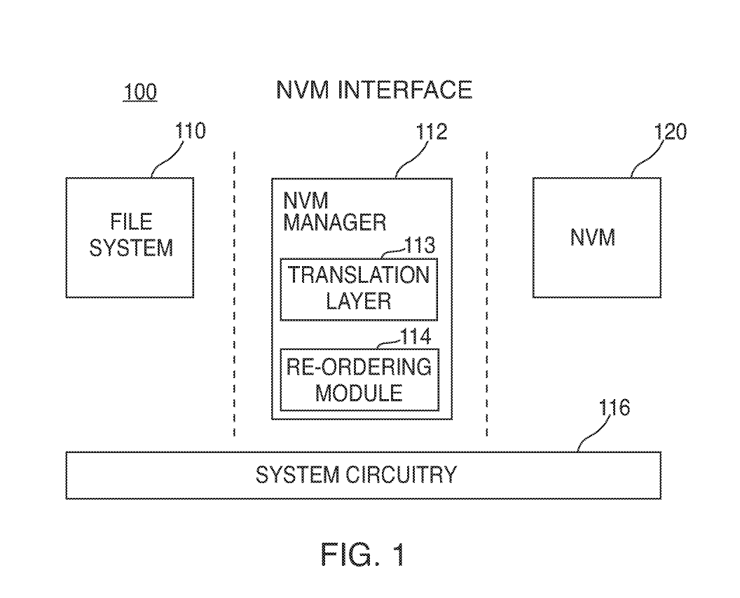

FIG. 1 illustrates a block diagram of a combination of firmware, software, and hardware components of system 100 in accordance with an embodiment of the invention. System 100 can include file system 110, NVM manager 112, system circuitry 116, and NVM 120. In some embodiments, file system 110 and NVM manager 112 may represent various software or firmware modules, and system circuitry 116 may represent hardware.

System circuitry 116 may include any suitable combination of processors, microprocessors, memory (e.g., DRAM), or hardware-based components (e.g., ASICs) to provide a platform on which firmware and software operations may be performed. In addition, system circuitry 116 may include NVM controller circuitry for communicating with NMV 120, and in particular for managing and/or accessing the physical memory locations of NVM 120. Memory management and access functions that may be performed by the NVM controller can include issuing read, write, or erase instructions and performing wear leveling, bad block management, garbage collection, logical-to-physical address mapping, SLC or MLC programming decisions, applying error correction or detection, and data queuing to set up program operations.

In one embodiment, NVM controller circuitry can be implemented as part of a “host” side of system 100. Host side NVM controllers may be used when NVM 120 is “raw NVM” or NVM having limited or no controller functionality. As used herein, “raw NVM” may refer to a memory device or package that may be managed entirely by a controller external to the NVM package. NVM having limited or no controller functionality can include hardware to perform, for example, error code correction, but does not perform memory management functions.

In another embodiment, the NVM controller circuitry can be implemented by circuitry included as part of the package that constitutes NVM 120. That is, the package can include the combination of the NVM controller and raw Nand. Examples of such packages include USB thumbdrives and SDcards.

NVM 120 can include NAND flash memory based on floating gate or charge trapping technology, NOR flash memory, erasable programmable read only memory (“EPROM”), electrically erasable programmable read only memory (“EEPROM”), Ferroelectric RAM (“FRAM”), magnetoresistive RAM (“MRAM”), or any combination thereof. NVM 120 can be organized into “blocks”, which is the smallest erasable unit, and further organized into “pages”, which can be the smallest unit that can be programmed or read. In some embodiments, NVM 120 can include multiple dies, where each die may have multiple blocks. The blocks from corresponding die (e.g., blocks having the same position or block number) may form “super blocks”. Each memory location (e.g., page or block) of NVM 120 can be addressed using a physical address (e.g., a physical page address or physical block address).

In some embodiments, the memory density of NVM 120 can be maximized using multi-level cell technology. MLC technology, in contrast to single level cell (“SLC”) technology, has two or more bits per cell. Each cell is commonly referred to as a page, and in a two-bit MLC NAND, for example, a page is split into an upper page and a lower page. The upper page corresponds to the higher order bit and the lower page corresponds to the lower order bit. Due to device physics, and upper-lower page NVM architecture, data can be read out of lower pages faster than upper pages.

File system 110 can include any suitable type of file system, such as a File Allocation Table (“FAT”) file system or a Hierarchical File System Plus (“HFS+”). File system 110 can manage file and folder structures required for system 100 to function. File system 110 may provide write and read commands to NVM manager 112 when an application or operating system requests that information be read from or stored in NVM 120. Along with each read or write command, file system 110 can provide a logical address indicating where the data should be read from or written to, such as a logical page address or a LBA with a page offset.

File system 110 may provide read and write requests to NVM manager 112 that are not directly compatible with NVM 120. For example, the LBAs may use conventions or protocols typical of hard-drive-based systems. A hard-drive-based system, unlike flash memory, can overwrite a memory location without first performing a block erase. Moreover, hard drives may not need wear leveling to increase the lifespan of the device. Therefore, NVM manager 112 can perform any functions that are memory-specific, vendor-specific, or both to handle file system requests and perform other management functions in a manner suitable for NVM 120.

NVM manager 112 can include translation layer 113 and re-ordering module 114. In some embodiments, translation layer 113 may be or include a flash translation layer (“FTL”). On a write command, translation layer 113 can map the provided logical address to a free, erased physical location on NVM 120. On a read command, translation layer 113 can use the provided logical address to determine the physical address at which the requested data is stored. For example, translation layer 113 can be accessed to determine whether a given LBA corresponds to a lower page or an upper page of NVM 120. Because each NVM may have a different layout depending on the size or vendor of the NVM, this mapping operation may be memory and/or vendor-specific. Translation layer 113 can perform any other suitable functions in addition to logical-to-physical address mapping. For example, translation layer 113 can perform any of the other functions that may be typical of flash translation layers, such as garbage collection and wear leveling.

Re-ordering module 114 may be operative to re-order the sequence in which LBAs are to be read out of NVM 120. As will be explained in more detail below, timing efficiencies are realized if a lower page is read before an upper page in a multiple page read operation. Re-ordering module 114 may process a read instruction received from file system 110 and determine whether a read sequence of the LBAs associated with the read instruction should be re-ordered.

NVM manager 112 may interface with a NVM controller (included as part of system circuitry 116) to complete NVM access commands (e.g., program, read, and erase commands). The NVM controller may act as the hardware interface to NVM 120, and can communicate with NVM package 120 using the bus protocol, data rate, and other specifications of NVM 120.

NVM manager 112 may manage NVM 120 based on memory management data, sometimes referred to herein as “metadata”. The metadata may be generated by NVM manager 112 or may be generated by a module operating under the control of NVM manager 112. For example, metadata can include any information used for managing the mapping between logical and physical addresses, bad block management, wear leveling, ECC data used for detecting or correcting data errors, markers used for journaling transactions, or any combination thereof.

The metadata may include data provided by file system 110 along with the user data, such as a logical address. Thus, in general, “metadata” may refer to any information about or relating to user data or used generally to manage the operation and memory locations of a non-volatile memory. NVM manager 112 may be configured to store metadata in NVM 120.

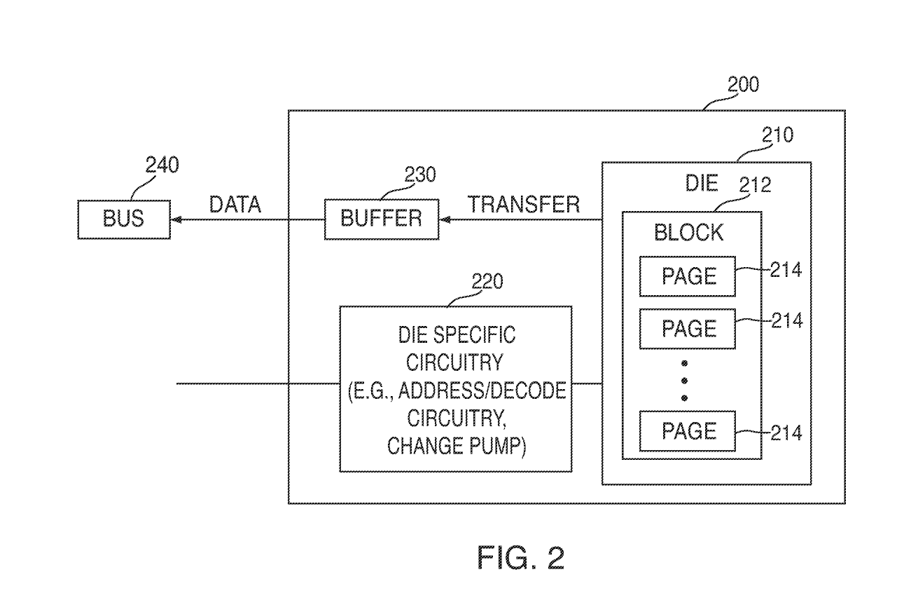

FIG. 2 is an illustrative block diagram showing in more detail a portion of NVM package 200 in accordance with an embodiment of the invention. NVM package 200 can include die 210, buffer 220, and die specific circuitry 230. Die 210 can include a predetermined number of physical blocks 212 and each block can include a predetermined number of pages 214. In some embodiments, pages 214 include upper and lower pages. Pages and blocks represent physical locations of memory cells within die 210. Cells within the pages or blocks can be accessed using die specific circuitry 220.

Die specific circuitry 220 can include circuitry pertinent to the electrical operation of die 210. For example, circuitry 220 can include circuitry such as row and column decode circuitry to access a particular page and charge pump circuitry to provide requisite voltage needed for a read, program, or erase operation. Die specific circuitry 220 is usually separate and distinct from any circuitry that performs management of the NVM (e.g., such as NVM manager 112 of FIG. 1) or any hardware generally associated with a host.

Buffer 230 can be any suitable structure for temporarily storing data. For example, buffer 230 may be a register. Buffer 230 may be used as an intermediary for transferring data between die 210 and bus 240. There are timing parameters associated with how long it takes for data to be transferred between bus 240 and buffer 230, and between buffer 220 and die 210. The timing parameters discussed herein are discussed in reference to read operations.

A read operation can include two parts: (1) a buffer operation, which is a transfer of data read from die 210 to buffer 230, and (2) a bus transfer operation, which is a transfer of data from buffer 230 to bus 240. Both operations have a time component. The buffering operation and the time required to fully perform it are referred to herein as Tbuff. The bus transfer operation and the time required to fully perform it are referred to herein as Txbus.

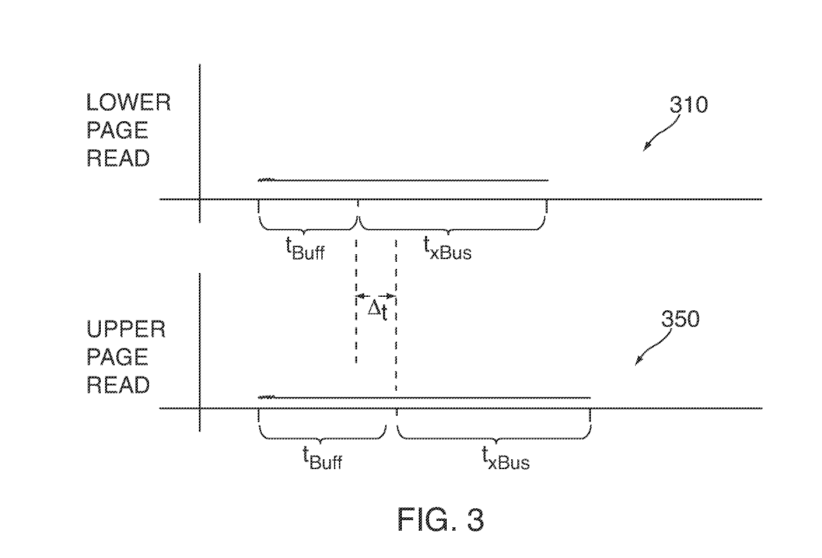

FIG. 3 illustrates timing diagrams 310 and 350 for performing a read operation on a lower page and an upper page, respectively, in accordance with embodiments of the invention. Lower page timing diagram 310 and upper page timing diagram 350 both show illustrative timing parameters Tbuff and Txbus. As shown, the Tbuff for a lower page read operation is less than the Tbuff for an upper page read operation. The time difference between the two is illustrated by the (Delta)t. The time for performing the bus transfer operation (Txbus) for both lower and upper pages can be identical or nearly identical.

In certain system configurations, only one page of data can be transmitted over a bus at any given time during a multiple page read operation. For example, assume there are two dies in operative communication with one bus. As the buffer for a first die is providing its stored data to the bus, the other buffer has to wait until the bus transfer operation is complete before it can begin providing its stored data to the bus. The transfer of data to the bus can alternate between buffers to maximize throughput of a read operation.

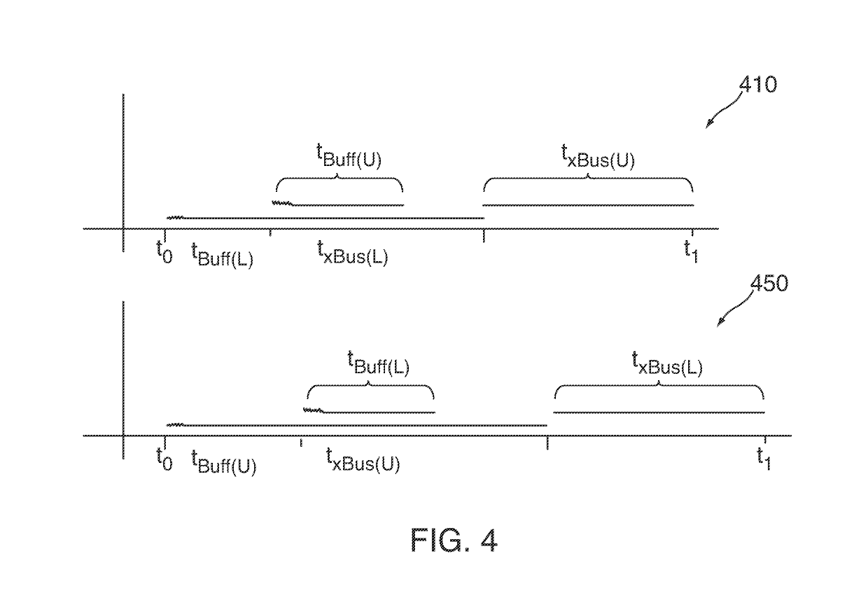

Embodiments of this invention further decrease latency of read operations by ensuring that lower page data is the first data set to be buffered and transferred to the bus in a read operation. Ensuring that lower page data is the first data set to be transferred, as opposed to upper page data, saves a (Delta)t in each multi-page read operation. A potential advantageous of reduced latency is increased throughput. The time savings is illustrated in FIG. 4. As shown, timing diagram 410 shows a multi-page read operation that starts with first buffering a lower page at time t0. The lower page buffering operation is labeled TBuff(L). At the end of TBuff(L), data is transferred from the buffer (containing the lower page data) to the bus, as indicated by TXBus(L). In addition, upper page data is buffered into a buffer, as indicated by TBuff(U). When the TXBus(L) operation is complete, the upper page data stored in a buffer is transferred to the bus, as indicated by TXBus(U). The multi-page read operation ends at time T1.

Timing diagram 450 shows a multi-page read operation that starts with first buffering an upper page at time T0. The buffering and bus transferring operations are similar to those discussed in connection with timing diagram 410, but because the multi-page read operation started with an upper page, the read operations ends at time T1+(Delta)t. Timing diagrams 410 and 450 show that it is preferable to start a multi-page read operation by first buffering a lower page. Accordingly, a NVM manager, or more particularly, a re-ordering module, can selectively re-order the sequence in which a multi-page read operation is executed.

The re-ordering module can selectively re-order the sequence of LBAs to be read from NVM on a per bus basis. That is, for any given bus, the re-ordering module can selectively re-order the LBA access sequence to maximize read operation throughput with respect to that bus. This way, despite which LBAs the file system requests for a read operation, the re-ordering module can minimize any unnecessary read operation delays by selectively re-ordering the access sequence of LBAs. Methods by which the re-ordering module operates is now discussed.

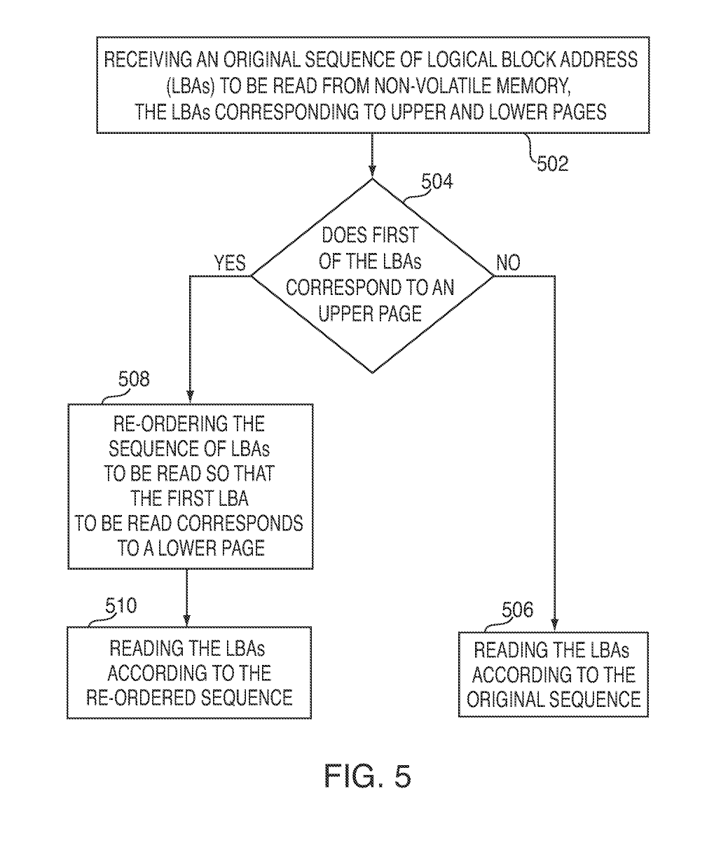

FIG. 5 illustrates a flowchart for selectively re-ordering a LBA access sequence in accordance with an embodiment of the invention. In a read operation, the file system provides an original sequence of LBAs to be retrieved from the NVM, as indicated by step 502. The LBAs correspond to upper and lower pages. At step 504, a determination is made if a first LBA in the original sequence corresponds to an upper page. The re-ordering module, operating in connection with the translation layer, can determine whether the first LBA in the sequence corresponds to a lower or upper page. As discussed above, the translation layer maintains, among other data, a logical-to-physical mapping of the LBAs. By accessing the translation layer, the re-ordering module can determine if the first LBA in the sequence corresponds to a lower or upper page.

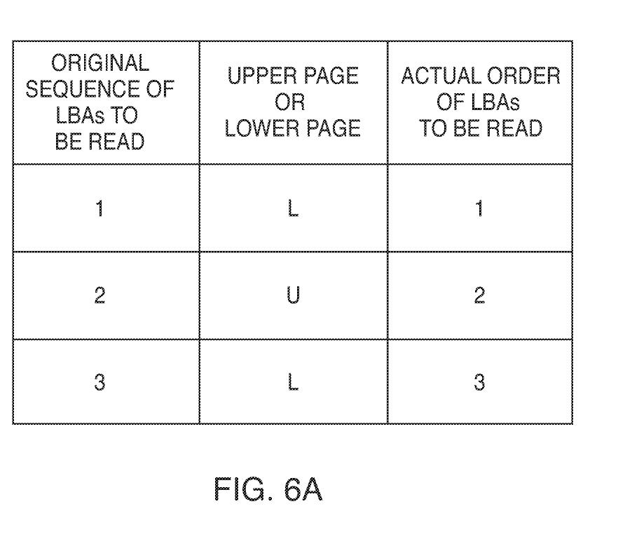

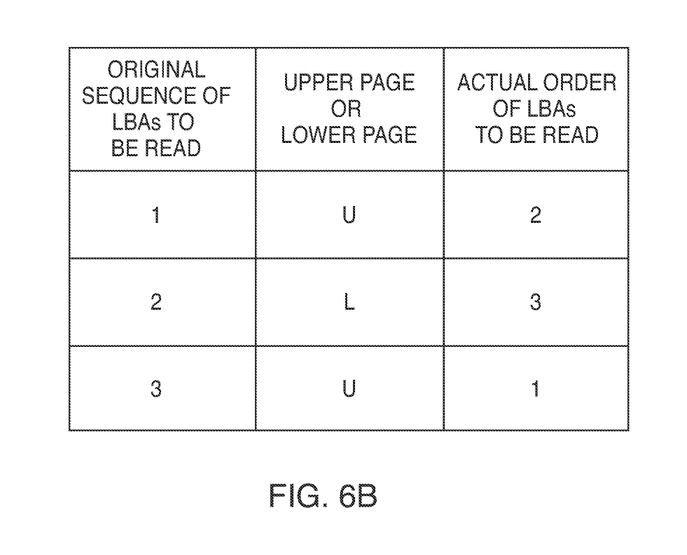

If the first LBA in the original sequence corresponds to a lower page, the sequence of the original LBAs is maintained and the method proceeds to step 506, which reads the LBAs according to the original sequence. Referring briefly to FIG. 6A, an illustrative example showing how the re-ordering module may selectively re-order the original sequence of LBAs is provided. The example shows the original sequence of LBAs to be read and whether the LBA corresponds to an upper or lower page. Here, the first LBA corresponds to a lower page. Accordingly, the re-ordering module need not disturb the order in which the LBAs are to be read. Thus, the actual order of LBAs to be read is the same as the original sequence of LBAs to be read.

If, at step 504, it is determined that the first LBA of the original sequence corresponds to an upper page, the method proceeds to step 508. At step 508, the original sequence of LBAs are re-ordered so that the first LBA to be read corresponds to a lower page. Re-ordering of LBAs can be performed in any number of different ways. For example, the re-ordering module may append the first LBA to the end of the last LBA in the sequence. As another example, the re-ordering module may insert the first LBA within the sequence somewhere between the second LBA and the last LBA. After the original sequence is re-ordered, the LBAs are read according to the re-ordered sequence, as indicated by step 510.

Referring briefly to FIG. 6B, another illustrative example showing how the re-ordering module may selectively re-order the original sequence of LBAs is provided. As shown, the first of the original sequence of LBAs to be read is an upper page. According, the re-ordering module selectively re-orders the original sequence to provide a re-ordered sequence of LBAs to be read. As shown, the actual order of LBAs to be read begins with LBA 2, which corresponds to a lower page.

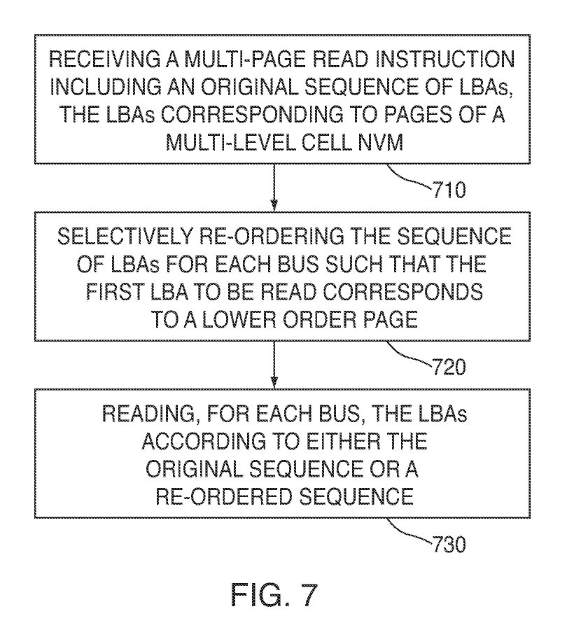

FIG. 7 shows an illustrative flow chart for selectively re-ordering pages corresponding to MLC NVM in accordance with an embodiment of the invention. The MLC NVM is operative communication with at least one bus. Beginning at step 710, a multi-page read instruction including an original sequence of logical block addresses (“LBAs”) is received. The LBAs correspond to pages of MLC NVM such as 2-bit MLC NVM, 3-bit MLC NVM, or 4-bit or higher MLC NVM. The pages of such MLC NVM may be referred to as lower order pages or higher order pages. Whether a page is a lower order page or a higher order page depends on what page it is being compared to. For example, in a 3-bit MLC NVM, there are three pages: a lower page, a middle page, and an upper page. The middle and upper pages are higher order pages compared to the lower page, and the lower and middle pages are lower order pages compared to the upper page. The lower the order of the page, the faster its data can be read out of NVM.

At step 720, the sequence of LBAs is selectively re-ordered for each bus such that the first LBA to be read corresponds to a lower order page. Depending on which bit MLC NVM is used, this may result in re-ordering one or more LBAs to achieve the desired sequence. In some embodiments, the original sequence can be re-ordered such that the first LBA corresponds to the lowest order page available in the sequence. The original sequence can be re-ordered using any number of suitable techniques. In one approach, a lower order page may be selected to be the first page of the re-ordered sequence. In another approach, one or more higher order pages may be appended to the end of the original sequence.

The original sequence may be re-ordered if it is determined that that first LBA in the sequence corresponds to a higher order page. This determination can be made by accessing a logical-to-physical translation table (e.g., stored in translation layer 113 of FIG. 1). If it is determined that the first LBA in the original sequence corresponds to a higher order page, the original sequence is re-ordered. If it is determined that the first LBA corresponds to a lower order page, the original sequence may be maintained.

At step 730, for each bus, the LBAs are read according to either the original sequence or a re-ordered sequence. The system may include multiple busses, each of which may transmit data based on selectively re-ordered multi-page read operations. For example, in a two bus system, multi-page read operations may be re-ordered for one of the buses, but not the other. Alternatively, the multi-page read operations may be re-ordered or maintained in the original sequence for both buses.

It should be understood that the steps included in flowcharts of FIGS. 5 and 7 are merely illustrative. Any of the steps may be removed, modified, or combined, and any additional steps may be added, without departing from the scope of the invention.

The described embodiments of the invention are presented for the purpose of illustration and not of limitation.

What is claimed is:

1. A method comprising:
receiving an original sequence of logical block addresses (LBAs) to be read from non-volatile memory, the LBAs corresponding to upper and lower pages;
determining if a first LBA of the sequence corresponds to an upper page;
re-ordering the sequence of LBAs to be read so that the first LBA to be read corresponds to a lower page if the first LBA corresponds to an upper page; and
reading the LBAs according to the reordered sequence.

2. The method of claim 1, further comprising:
determining if the first LBA corresponds to a lower page; and
reading the LBAs according to the original sequence.

3. The method of claim 1, wherein re-ordering the sequence of LBAs comprises appending the first LBA to the end of a last LBA in the original sequence to provide the reordered sequence.

4. The method of claim 1, wherein re-ordering the sequence of LBAs comprises reordering the original sequence by selecting a second LBA that corresponds to a lower page to be the first page of the re-ordered sequence.

5. The method of claim 1, wherein reading comprises, for each LBA:
transferring data from the non-volatile memory to a buffer; and
after the data has been transferred to the buffer, transferring data from the buffer to a bus.

6. The method of claim 4, wherein a time period for transferring data from the non-volatile memory to the buffer is less for a lower page than for an upper page.

7. The method of claim 1, wherein the non-volatile memory is nand flash memory.

8. A system comprising:
non-volatile memory (“NVM”) comprising a plurality of die, each die having a plurality of blocks each including lower and upper pages;
a plurality of buffers for storing data to be provided to or retrieved from the NVM, wherein each die is in communication with one of the buffers;
a bus operative to provide data to or receive data from the plurality of buffers;
a NVM manager operative to communicate with the NVM, the NVM manager operative to:
receive a read instruction including an original sequence of logical block addresses (“LBAs”) that correspond to upper and lower pages, wherein the sequence is arranged such that the LBAs correspond to alternating upper and lower pages, and wherein a first LBA corresponds to either a lower or upper page;
determine if the first LBA corresponds to an upper page;
if the first LBA is determined to correspond to an upper page, reorder the sequence to produce a reordered sequence having the first LBA correspond to an upper page; and
pass the read instruction including the reordered sequence to the NVM.

9. The system of claim 8, wherein the NVM manager is operative to:
determine if the first LBA of the original sequence corresponds to a lower page; and
pass the read instruction including the original sequence to the NVM.

10. The system of claim 8, wherein the NVM manager is operative to:
reorder the original sequence to produce the re-ordered sequence by appending the first LBA of the original sequence after a last LBA of the original sequence.

11. The system of claim 8, wherein the NVM manager is operative to:
reorder the original sequence to produce the re-ordered sequence by selecting a second LBA that corresponds to a lower page to be the first page of the re-ordered sequence.

12. The system of claim 8, wherein the NVM is nand flash.

13. A method implemented in a system comprising non-volatile memory (“NVM”), at least one bus, and a NVM manager, the method comprising:
receiving a multi-page read instruction including an original sequence of logical block addresses (“LBAs”), the LBAs corresponding to pages of a multi-level cell NVM;
selectively re-ordering the sequence of LBAs for each bus such that the first LBA to be read corresponds to a lower order page; and
reading, for each bus, the LBAs according to either the original sequence or a re-ordered sequence.

14. The method of claim 13, wherein selectively re-ordering the sequence of LBAs for each bus comprises:
determining if a first LBA corresponds to a higher order page; and
re-ordering the original sequence to provide a re-ordered sequence if the first LBA corresponds to a higher order page.

15. The method of claim 14, wherein determining if a first LBA corresponds to a higher order page comprises accessing a logical-to-physical translation table.

16. The method of claim 14, wherein re-ordering the original sequence comprises appending the first LBA to a last LBA in the original sequence.

17. The method of claim 14, wherein re-ordering the original sequence comprises selecting a second LBA that corresponds to a lower page to be the first page of the re-ordered sequence.

18. The method of claim 13, wherein selectively re-ordering the sequence of LBAs for each bus comprises:
determining if a first LBA corresponds to a lower order page; and
maintaining the original sequence if the first LBA corresponds to a lower order page.

19. The method of claim 12, wherein the MLC NVM is a 2-bit per cell NVM.

20. The method of claim 12, wherein the MLC NVM is a 3-bit more per cell NVM.

21. The method of claim 12, wherein lower order page corresponds to a bit lower in order than a bit corresponding to a higher order page.
